(19) United States
(12) Patent Application Publication
(10) Pub. No.: US 2009/0086050 A1
(43) Pub. Date: Apr. 2, 2009

(54) IMAGE CAPTURE DEVICE AND IMAGE CAPTURE METHOD

(76) Inventor: Akihiro Kasakawa, Miyagi (JP)

Correspondence Address: BIRCH STEWART KOLASCH & BIRCH, PO BOX 747, FALLS CHURCH, VA, 22040-0747, US

(21) Appl. No.: 12/235,364

(22) Filed: Sep. 22, 2008

(30) Foreign Application Priority Data
Sep. 28, 2007 (JP) 2007-253343

(51) Int. Cl. H04N 5/228

(52) U.S. Cl. 348/222.1; 348/E05.031

(57) ABSTRACT

An image capture device including an image capture unit, an auxiliary light source, a face region extraction unit, a determination unit, a relative position information acquiring unit, and a notification unit. The face region extraction unit extracts a region corresponding to a face from the captured image data. The determination unit determines the orientation of the face in the extracted face region, and the relative position information acquiring acquires relative position information of the optical system component with respect to the auxiliary light source based on the determination result of the determination unit. The notification unit gives a notification when the acquired relative position information matches with predetermined reference information.

### CROSS-REFERENCE TO RELATED APPLICATION

This application claims priority under 35 USC 119 from Japanese Patent Application No. 2007-253343, the disclosure of which is incorporated by reference herein.

### BACKGROUND OF THE INVENTION

1. Field of the Invention

The present invention relates to an image capture device performing detection of image capture orientation, and to an image capture method of the same.

2. Description of the Related Art

When image capturing using an image capture device such as a digital camera, the photographer determines the angle of view while confirming the angle by looking through a finder, or by looking at an LCD display (i.e., looking at a through image). A flash is often built into an image capture device, and a photographic subject can be illuminated by emitting the flash when peripheral light is insufficient in image capture. The flash is emitted in such cases whatever the orientation the image capture device is readied to the photographic subject.

In order to address the above, Japanese Patent Application Laid-Open (JP-A) No. 2003-66520 describes a technique in which a horizontal/vertical (landscape/portrait) orientation detection sensor is used for detecting whether the image capture device is orientated horizontally, or vertically, with respect to the photographic subject by a photographer.

However, although image capture can be accomplished with JP-A No. 2003-66520 without the application of unnatural shadows to a photographic subject, the number of components is increased, since a horizontal/vertical orientation detection sensor is used.

### SUMMARY OF THE INVENTION

In consideration of the above circumstances, the present invention provides an image capture device capable of avoiding applying unnatural shadows to a photographic subject, without an increase in the number of components, and an image capture method of the same.

A first aspect of the present invention is an image capture device including: an image capture unit that acquires image data by image capturing a photographic subject by image capture elements using an optical system component; an auxiliary light source, positioned away from the position of the optical system component in a specific direction, that outputs auxiliary light substantially simultaneously with the image capture by the image capture unit; a face region extraction unit that extracts a region corresponding to a face from the captured image data; a determination unit that determines the orientation of the face in the extracted face region of the image data on the basis of at least the position of the image capture unit in a rotation direction centered around the image capture optical axis; a relative position information acquiring unit that acquires relative position information of the optical system component with respect to the auxiliary light source on the basis of the determination result of the determination unit; and a notification unit that gives a notification when the acquired relative position information matches predetermined reference information, the notification comprising information relating to the match.

According to the first aspect of the present invention, relative position information of the optical system component with respect to the auxiliary light source can be acquired by determining the face orientation with the determination unit. A detection component or the like is therefore not required in order to acquire the relative position information of the optical system component with respect to the auxiliary light source.

In the image capture device of the first aspect, the predetermined reference information may be related to the state of a shadow of the photographic subject generated by the auxiliary light output from the auxiliary light source.

According to the above configuration, warning (notification) can be given that an unnatural state of the shadow of the photographic subject will arise due to the auxiliary light source.

In the image capture device of the first aspect, the predetermined reference information may represent a relative positional relationship in which the position of the auxiliary light source is below the position of the optical system component in the direction of gravity.

According to the above configuration, warning (notification) can be given of the auxiliary light source being below the position of the optical system component in the direction of gravity and that an unnatural state of the shadows of the photographic subject will arise.

The image capture device of the first aspect may further include a display unit for displaying the captured image data, and when the predetermined reference information matches the position information, the notification unit may display the information relating to the match in an orientation corresponding to the orientation of an upright image of the photographic subject, regardless of the orientation of the image capture device during image capture.

According to the above configuration, the display unit displays information so as to match display to the orientation of the photographic subject, and such information becomes easier to recognize.

In the image capture device of the first aspect, when plural face regions are extracted, the determination unit may determine, as the face orientation to be compared with the predetermined reference information, a face orientation that substantially matches the greatest number of face orientations of the plural face regions.

According to the above configuration, by making the orientation of the greatest number of faces to be the overall face orientation, when plural persons are image captured as the photographic subject, the overall face orientation of the people can be accurately obtained.

In the image capture device of the first aspect, when plural face regions are extracted and there is more than one face orientation that substantially matches the greatest number of face orientations of the plural face regions, the determination unit may determine a neck of a face to be bent if the angle formed between the perpendicular bisector of a straight line connecting the two eyes of the face of the photographic subject and an edge line of the neck of the photographic subject is a specific angle or greater.

According to the above configuration, photographic subjects with bent necks can be determined by also using the edge line of the neck in determining the face orientation.

In the image capture device of the first aspect, when plural face regions are extracted and there is more than one face orientation that substantially matches the greatest number of face orientations of the plural face regions, the determination unit may compare the orientation of faces having an angle that is smaller than a specific angle formed between the perpendicular bisector of a straight line connecting the two eyes of the face of the photographic subject and an edge line of the neck of the photographic subject, and determine the overall face orientation to be the face orientation that substantially matches the greatest number of face orientations of the compared faces.

According to the above configuration, when there are people with bent necks, the overall face orientation of the people can be accurately obtained from the face orientation of the greatest number of faces that are substantially the same as each other from face orientations of people without bent necks.

A second aspect of the present invention is an image capture method including: acquiring image data by image capturing a photographic subject by image capture elements using an optical system component; optionally outputting auxiliary light from an auxiliary light source, positioned away from the position of the optical system component in a specific direction, substantially simultaneously with the image capture by the image capture unit; extracting a region corresponding to a face from the image data captured during image capture when auxiliary light is outputted by the auxiliary light source output; determining the orientation of the face in the extracted face region image data, with respect to the optical system component; acquiring relative position information of the optical system component with respect to the auxiliary light source on the basis of the determined result; and giving a notification when the acquired relative position information matches predetermined reference information the notification comprising information relating to the match.

According to the second aspect of the present invention, a face can be detected from the image data obtained in image capture and the image capture orientation can be detected, without the addition of a detection component for extracting the image capture orientation. It is thereby possible to warn a photographer when the light source is below, and photographic subjects can be photographed without an application of unnatural shadows thereto.

In method of the second aspect, the reference information may be related to the state of a shadow of the photographic subject generated by the auxiliary light output from the auxiliary light source.

In the method of the second aspect, the reference information may represent a relative positional relationship in which the position of the auxiliary light source is below the position of the optical system component in the direction of gravity.

The method of the second aspect may further include displaying the captured image data, and when the predetermined reference information matches the position information, information relating to the match may be displayed in an orientation corresponding to the orientation of an upright image of the photographic subject, regardless of the orientation during image capture.

In the method of the second aspect, when plural face regions are extracted, the face orientation to be compared with the predetermined reference information may be determined to be a face orientation that substantially matches the greatest number of face orientations of the plural face regions.

In the method of the second aspect, when there are plural face regions extracted and there is more than one face orientation that substantially matches the greatest number of face orientations of the plural face regions, a neck of a face may be determined to be bent if the angle formed between the perpendicular bisector of a straight line connecting the two eyes of the face of the photographic subject and an edge line of the neck of the photographic subject is a specific angle or greater.

In the method of the second aspect, when there are plural face regions extracted and there is more than one face orientation that substantially matches the greatest number of face orientations of the plural face regions, comparison may be made between the orientations of faces having an angle that is smaller than a specific angle formed between the perpendicular bisector of a straight line connecting the two eyes of the face of the photographic subject and an edge line of the neck of the photographic subject, and the overall face orientation may be determined to be the face orientation that substantially matches the greatest number of face orientations of the compared faces.

Thus, as explained above, an image capture device capable of avoiding application of unnatural shadows to a photographic subject when image capturing, without increasing the number of components of the image capture device, and an image capture method capable of the same can be provided.

### BRIEF DESCRIPTION OF THE DRAWINGS

Exemplary embodiments of the present invention will be described in detail based on the following figures, wherein:

FIG. 1A is a diagram showing the front face of a digital camera according to a first exemplary embodiment;

FIG. 1B is a diagram showing the top face of a digital camera according to the first exemplary embodiment;

FIG. 1C is a diagram showing the back face of a digital camera according to the first exemplary embodiment;

FIG. 2 is a block diagram showing important components configuring the electrical system of a digital camera according to the first exemplary embodiment;

FIG. 3 is a diagram showing an example of horizontal/vertical direction determination of a person's face;

FIG. 4 is a functional block diagram according to the first exemplary embodiment;

FIG. 5 is a diagram showing examples of the orientation of readying a digital camera and the image data captured thereby according to the first exemplary embodiment;

FIG. 6 is a diagram showing an example of a message displayed in a warning (notification) processing according to the first exemplary embodiment;

FIG. 7 is a flow chart showing a processing flow for determination of the position of a lens and a flash with respect to a photographic subject of a person in image capture according to the first exemplary embodiment;

FIG. 8 is a diagram showing an example of a message displayed in the warning (notification) processing according to the first exemplary embodiment;

FIG. 9 is a diagram showing an example of face horizontal/vertical direction determination when there are plural persons as the photographic subject according to a second exemplary embodiment;

FIG. 10A is a diagram showing an example of face horizontal/vertical direction determination when there are plural persons as the photographic subject according to the second exemplary embodiment;

FIG. 10B is a diagram showing an example of face horizontal/vertical direction determination when there are plural persons as the photographic subject according to the second exemplary embodiment;

FIG. 11A is a diagram showing an example of face horizontal/vertical direction determination when there are plural persons as the photographic subject according to the second exemplary embodiment;

FIG. 11B is a diagram showing an example of face horizontal/vertical direction determination when there are plural persons as the photographic subject according to the second exemplary embodiment; and

FIG. 12 is a flow chart showing a processing flow for determination of the position of a lens and a flash with respect to a photographic subject of a person in image capture according to the second exemplary embodiment.

### DETAILED DESCRIPTION OF THE INVENTION

### First Exemplary Embodiment

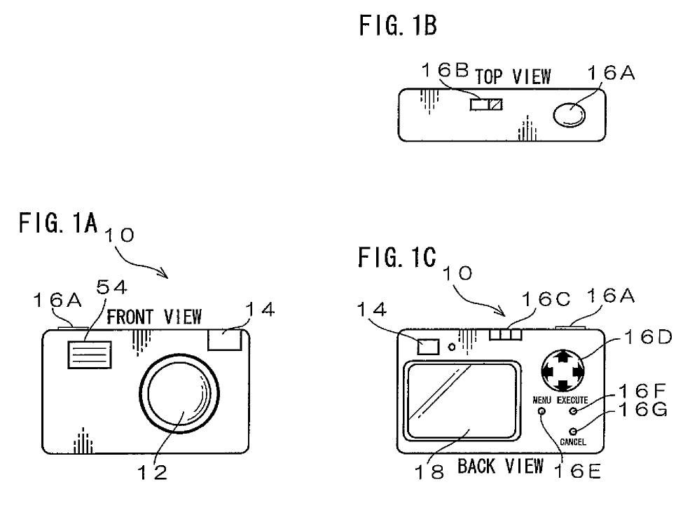

FIGS. 1A to 1C show the external appearance of a configuration of a digital camera 10 according to a first exemplary embodiment.

A lens 12 for focusing the image of a photographic subject, a finder 14 used for determining the composition of the photographic subject being image captured, and a flash 54 for emitting light to illuminate the photographic subject when necessary during image capture, are provided on the front face of the digital camera 10, as shown in FIG. 1A. A release button (so-called shutter) 16A and a power switch 16B are provided on the top face of the digital camera 10, as shown in FIG. 1B, these being operated by being pressed by a photographer when executing image capture.

The release button 16A according to the first exemplary embodiment is configured capable of detecting two stages of being depressed, a state when depressed to an intermediate position (referred to below as the “half-pressed state”) and a sate when depressed past the intermediate position to the fully depressed position (referred to below as the filly-pressed state”.

In the digital camera 10 according to the first exemplary embodiment, an AE (Automatic Exposure) function operates to set the exposure conditions (shutter speed, aperture) by the release button 16A being placed in the half-pressed state, and then an AF (Auto Focus) function operates to control the focusing. Exposure (image capture) is then performed by continuing and maintaining the fully-pressed state.

On the back face of the digital camera 10 are provided, as shown in FIG. 1C: a later described eye piece of the finder 14; a liquid crystal display (referred to below as “LCD”) 18 for displaying the photographic subject using digital image data obtained by image capture and for displaying various menu screens, messages and the like; a mode switching switch 16C, slide operated to set one or other mode from an image capture mode for performing image capture and a reproduction mode in which digital image data obtained by image capture is used to display (reproduce) the photographic subject on the LCD 18; and a cross cursor button 16D, including four arrow keys for indicating the four movement directions on the LCD 18 display region, up, down, left and right.

On the back face of the digital camera 10 there is also provided: a menu key 16E, press-operated for displaying a main menu screen on the LCD 18; an execution key 16F, press-operated to execute the processing specified on the menu screen; and a cancel key 16G, press-operated to stop (cancel) various operations.

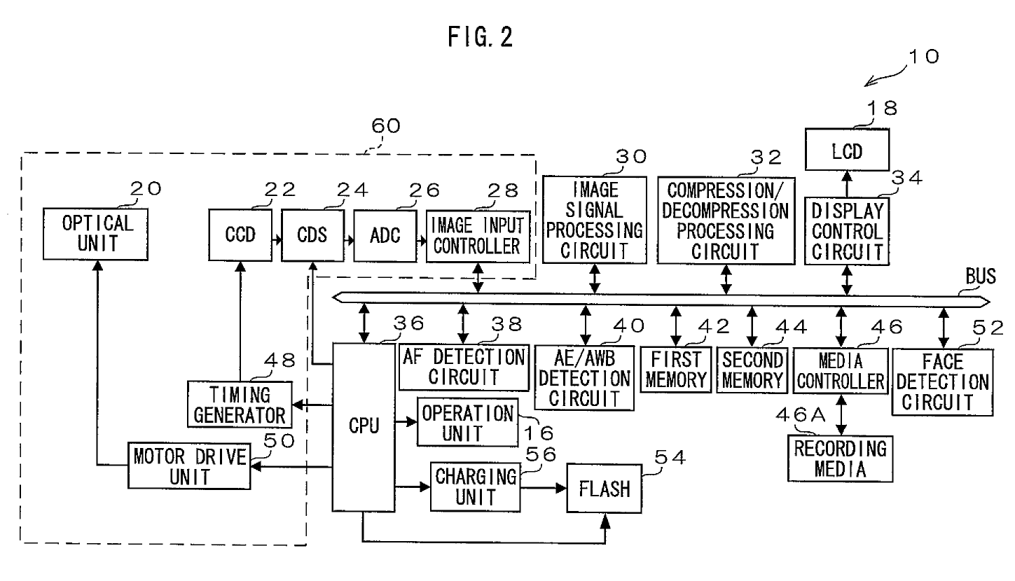

Next, FIG. 2 shows a configuration of the electrical system of the digital camera 10 according to the first exemplary embodiment.

The digital camera 10, as shown in FIG. 2, is configured to include: an optical unit 20, which includes the lens 12; a CCD 22, disposed on the optical axis to the rear of the lens 12; a correlated double sampling circuit (referred to below as “CDS”) 24; and an analogue/digital converter (referred to below as “ADC”) 26 for converting input analogue signals into digital data. The output terminal of the CCD 22 is connected to the input terminal of the CDS 24, and the output terminal of the CDS 24 is connected to the input terminal of the ADC 26.

The processing of the correlated double sampling performed by the CDS 24 is designed to reduce the noise (in particular thermal noise) and the like included in the output signal from the solid-state image capture elements. The processing therein is able to obtain accurate pixel data by taking the difference between the level of the feed-through component and the level of the pixel signal component that are included in the output signal of each individual pixel of the solid-state image capture element.

The digital camera 10 is also configured with: an image input controller 28, incorporating a specific capacity of line buffer internally, and controlling direct storing of input digital image data in a specific region of a second memory 44 (later described); an image signal processing circuit 30, applying various types of image processing to digital image data; and a compression/decompression processing circuit 32 that carries out compression with a specific compression format to digital image data, and decompresses digital image data which has been compressed; and an LCD I/F (interface) 34, generating a signal for causing the LCD 18 to display an image of the digital image data and/or menu screens and the like, and supplying the signal to the LCD 18. The input terminal of the image input controller 28 is connected to the output terminal of the ADC 26.

The digital camera 10 is also configured to include: a CPU (Central Processing Unit) 36 for overall operation of the digital camera 10; an AF detection circuit 38 for detecting physical quantities necessary for operating the AF function; an AE/AWB detection circuit 40 for detecting physical quantities necessary for operating the AE and the AWB (Automatic White Balance) functions; a first memory 42, configured from SDRAM (Synchronous Dynamic Random Access Memory) for use as a work area when executing various processes using the CPU 36; a second memory 44, configured from VRAM (Video RAM) for mainly storing digital image data obtained by image capture; and a face detection circuit 52, for detecting whether a face of a person is present in digital image data obtained by image capture.

The face detection circuit 52, for example, determines in advance ranges that correspond to skin color of people in brightness signals and color signals (chroma signals), and determines whether the brightness signal and color signal of each of the pixels of digital image data, representing the photographic subject obtained by image capture using the CCD 22, fall within these ranges or not, and extracts as skin color regions any contiguous regions determined as having skin color. Face regions may be determined using a method such as one in which clusters are derived from a two-dimensional histogram of hue and saturation, and determination is then made from the internal structure, shape, and connectivity to outside structures of the clusters.

The digital camera 10 is also configured to include a media controller 46 for making a recording media 46A accessible in the digital camera 10.

The image input controller 28, the image signal processing circuit 30, the compression/decompression processing circuit 32, the LCD I/F 34, the CPU 36, the AF detection circuit 38, the AE/AWB detection circuit 40, the first memory 42, the second memory 44, the media controller 46 and the face detection circuit 52 are each respectively mutually connected together through a BUS.

A timing generator 48 is provided in the digital camera 10, mainly for generation of a timing signal for driving the CCD 22 and supplying the timing signal to the CCD 22. The input terminal of the timing generator 48 is connected to the CPU 36, and the output terminal of the timing generator 48 is connected to the CCD 22, with driving of the CCD 22 controlled by the CPU 36 through the timing generator 48.

The CPU 36 is also connected to the input terminal of the motor drive unit 50, and the output terminal of the motor drive unit 50 is connected to a focus adjustment motor, a zoom motor and an aperture motor of the optical unit 20.

The lens 12 included in the optical unit 20 according to the first exemplary embodiment of the present invention has several lenses, and is configured to be a zoom lens capable of changing the focal distance (varying the magnification), and the lens 12 is provided with a unillustrated lens drive mechanism. This lens drive mechanism includes the above focus adjustment motor, the zoom motor and the aperture motor. The focus adjustment motor, the zoom motor and the aperture motor are each driven by drive signals supplied from the motor drive unit 50 under the control of the CPU 36.

In order to change the zoom magnification of the optical system the CPU 36 controls the driving of the zoom motor and changes the focal distance of the lens 12 included in the optical unit 20.

The CPU 36 controls the focus by controlling the driving of the focus adjustment motor so that the contrast of the image obtained by image capture with the CCD 22 is maximized. Namely the digital camera 10 according to the first exemplary embodiment sets the position of the lenses such that the contrast of the read-out image is maximized, using a “TTL” (Through The Lens) method.

In addition, the operation unit 16, which includes the release button 16A, the power switch 16B, the mode switching switch 16C, the cross cursor button 16D, the menu key 16E, the execution key 16F and the cancel key 16G, is connected to the CPU 36. The CPU 36 is able to continuously ascertain the operational status for these respective portions of the operation unit 16.

The digital camera 10 is also provided with a charging unit 56, positioned between the CPU 36 and the flash 54, for charging up with power in order to emit light from the flash 54 under control of the CPU 36. The flash 54 is also connected to the CPU 36 and light emission of the flash 54 is controlled by the CPU 36.

The optical unit 20, the CCD 22, the CDS 24, the ADC 26, the image input controller 28, the timing generator 48, the and the motor drive unit 50 are collectively referred to as an image capture unit 60.

By detecting the face of a person, the digital camera 10 according to the first exemplary embodiment determines from the face of the detected person the vertical or horizontal direction of the person.

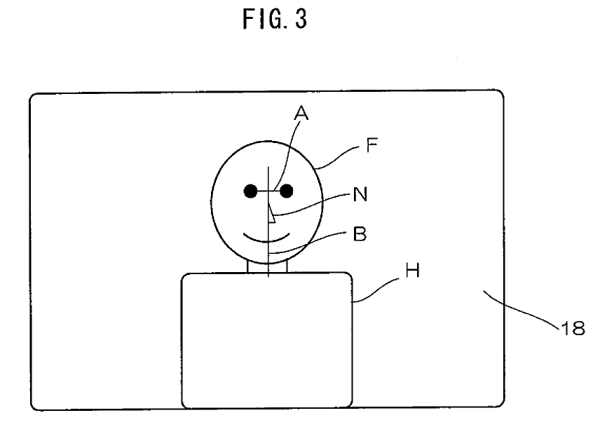

Explanation is given below, with reference to FIG. 3, of the determination of the horizontal/vertical direction of the person when the face of a person has been detected.

As shown in FIG. 3, the determination of the horizontal/vertical direction of the face F of a person H is made by the face detection circuit 52 (see FIG. 2), and the determination includes determining the straight line A connecting the two eyes in the detected face region to be the horizontal direction, and determining the perpendicular bisector line B of the straight line connecting the eyes to be in the vertical direction. It should be noted that the determination of the horizontal/vertical direction of the face F of the person H is in is not limited to the above method, and another method may be used therefor as long as the determination can be made of the horizontal/vertical direction of the face, such as using a straight line connecting the nostrils of the nose N, the edge line of the nose N, or the like.

The horizontal/vertical orientation of the readied (held) digital camera 10 (i.e., posture of the digital camera 10) is determined from the horizontal/vertical directions of the face F of the person H determined in the above manner. The photographer is warned when it is determined, based on the readied orientation of the digital camera 10 and based on the positional relationship between components of the digital camera 10, that the flash 54 is positioned below the lens 12 and that unnatural shadows will be applied to the photographic subject.

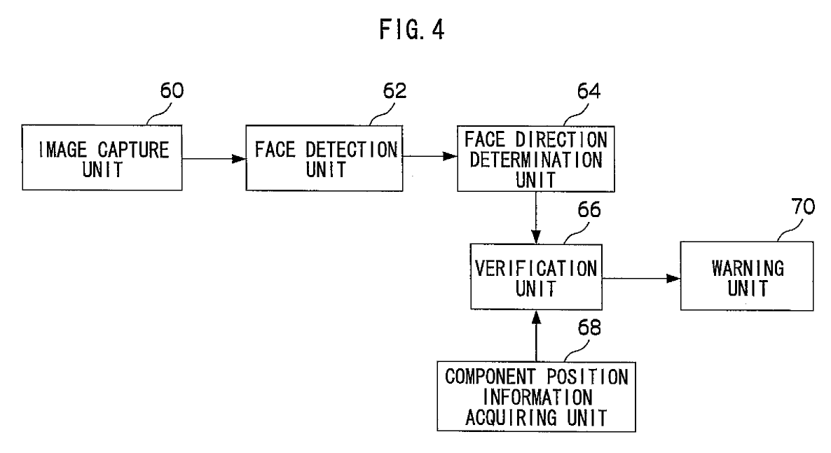

FIG. 4 is a functional block diagram showing determination of the positional relationship between the flash 54 and the lens 12 based on the horizontal/vertical directions of the face F of the person H according to the first exemplary embodiment.

The image capture unit 60 is connected to a face detection unit 62. The image capture unit 60 sends image data captured by the photographer in the image capture mode to the face detection unit 62.

The face detection unit 62 is connected to a face direction determination unit 64. The face detection unit 62 extracts, using the face detection circuit 52 (see FIG. 2), a region corresponding to the face F of the person H from the image data sent from the image capture unit 60. The extracted face data is sent to a face direction determination unit 64.

The face direction determination unit 64 is connected to a verification unit 66. The face direction determination unit 64 determines the horizontal/vertical direction of the face F of the person H from the face data sent from the face detection unit 62. The face direction determination unit 64 sends data for the determined horizontal/vertical direction for the face F to the verification unit 66.

A component position information acquiring unit 68 is connected to the verification unit 66. The component position information acquiring unit 68 acquires positional information about the lens 12 and the flash 54 of the digital camera 10. The component position information acquiring unit 68 sends the acquired positional information about the lens 12 and the flash 54 to the verification unit 66.

The verification unit 66 is connected to a warning (notification) unit 70. The verification unit 66 first determines the horizontal/vertical orientation of the readied digital camera 10 based the horizontal/vertical direction data of the face F determined by the face direction determination unit 64. Next, the verification unit 66 verifies whether there is a state which will apply unnatural shadows to the photographic subject when the photographic subject was illuminated with the flash 54. “A state which will apply unnatural shadows” is for example a state in which the flash 54 is located below the lens 12. Verification is made as to whether the flash 54 of the digital camera 10 is located below the lens 12 with respect to the photographic subject based on the positional information acquired by the component position information acquiring unit 68. The verification unit 66 sends a warning (notification) instruction to the warning unit 70 based on the result of the verification.

The warning unit 70 displays a message to be indicated to the photographer on the LCD 18, based on the warning instruction sent from the verification unit 66.

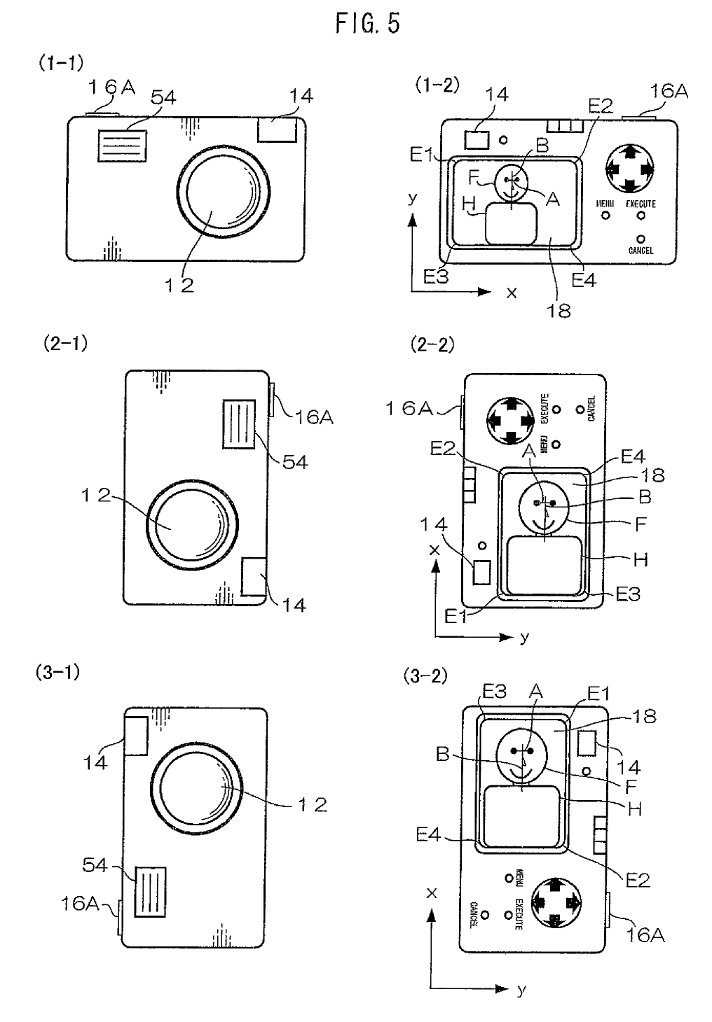

Explanation will now be given of the verification of the verification unit 66, with reference to FIG. 5. (1-1), (2-1) 5 and (3-1) of FIG. 5 are each orientations of the readied digital camera 10 with respect to the photographic subject of a person H, namely the horizontal/vertical orientation of the digital camera 10 held for a image capture as seen from the photographic subject. (1-2) of FIG. 5 is a view of the rear face of the digital camera 10 held in the orientation of (1-1) of FIG. 5 in the image capturing, (2-2) of FIG. 5 is a view of the rear face of the digital camera 10 held in the orientation of (2-1) of FIG. 5 in the image capturing, and (3-2) of FIG. 5 is a view of the rear face of the digital camera 10 readied in the orientation of (3-1) of FIG. 5 in the image capturing. The readout scanning direction of charge from the image capture elements of the CCD 22 is designated as the x-direction, and the direction orthogonal to the scanning direction is designated as the y-direction. The x-direction of the digital camera 10 is the horizontal direction when the digital camera 10 is held in the horizontal orientation ((1-1) of FIG. 5), and the y-direction is the horizontal direction when the digital camera 10 is held in the vertical orientation ((2-1) and (3-1) of FIG. 5). The apexes of the finder 18 of the LCD 18 are designated as E1, E2, E3 and E4, respectively.

The face F of the image data shown in (1-2) of FIG. 5 has straight line A connecting the two eyes in a substantially horizontal direction. The x-direction matches this horizontal direction of the face F, and the y-direction matches a vertical direction of the face F. Since the horizontal direction of the face F (x-direction) matches the horizontal direction (x-direction) of the digital camera 10 when the digital camera is held horizontally, the digital camera 10 is considered to be orientated horizontally (landscape orientation). Since the flash 54 is positioned in the direction E2 of the finder 18, light is emitted above with respect to the person H.

Explanation will now be given of a case in which image data such as that shown in (2-2) of FIG. 5 is captured in the digital camera 10. The image data that is shown in (2-2) of FIG. 5 indicates that the horizontal direction of the face is in the y-direction, according to the straight line A connecting the two eyes. Since the horizontal direction (y-direction) of the face F matches the horizontal direction (y-direction) of the digital camera 10 when the digital camera 10 is held vertically, the digital camera 10 is considered to be oriented vertically (portrait orientation). Since the flash 54 is positioned in the E2 direction of the finder 18, light is emitted from above with respect to the person H.

Explanation will now be given of when image data such as that shown in (3-2) of FIG. 5 is image captured by the digital camera 10. The image data shown in (3-2) of FIG. 5 indicates that the horizontal direction of the face is in the y-direction, according to the straight line A connecting the two eyes. Since the horizontal direction of the face F (y-direction) matches the horizontal direction (y-direction) of the digital camera 10 oriented in the vertical orientation, the digital camera 10 is considered to be oriented vertically. Since the flash 54 is positioned in the E2 direction of the finder 18, light is emitted from below with respect to the person H. In such a case the verification unit 66 sends a warning instruction to the warning unit 70.

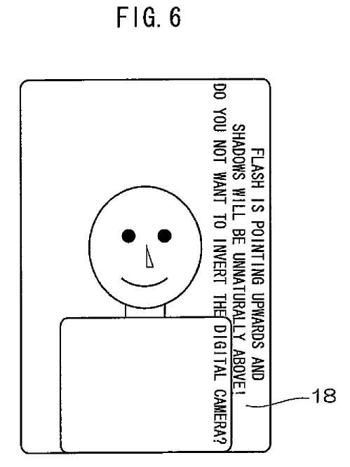

FIG. 6 shows an example of a message for display on the LCD 18. As shown in FIG. 6, a message is displayed at the upper position of the image capture screen when the digital camera 10 is held in the orientation shown in (1-1) of FIG. 5, warning the photographer that unnatural shadows will result.

Explanation is given below of the operation of the first exemplary embodiment.

In the digital camera 10, the face direction determination unit 64 determines the horizontal/vertical directions of the face F of a person H from the image data captured by the image capture unit 60, and data regarding the determined horizontal/vertical direction of the face F is sent to the verification unit 66. The component position information acquiring unit 68 acquires positional information about the components of the digital camera 10 and sends this information to the verification unit 66. The verification unit 66 determines the horizontal/vertical orientation of the digital camera 10 based on the horizontal/vertical direction data of the face F sent from the face direction determination unit 64 and based on the positional information sent from the component position information acquiring unit 68. When it is verified that the flash 54 is below the lens 12 and that unnatural shadows would be applied to the photographic subject the verification unit 66 sends a warning instruction to the warning unit 70.

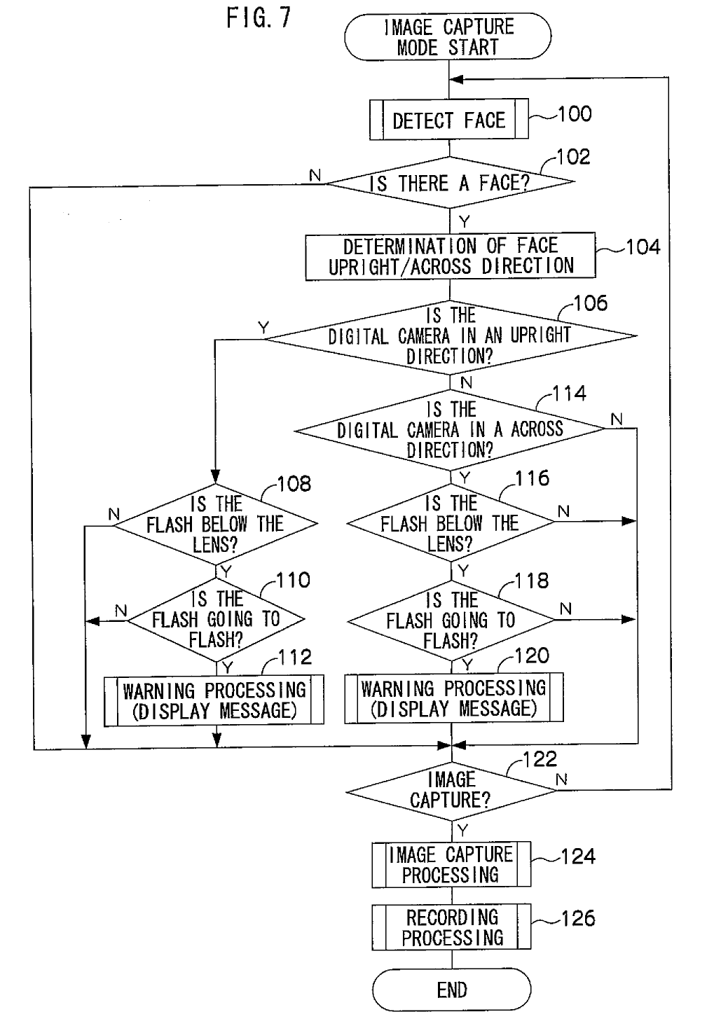

FIG. 7 is a flow chart showing a flow of processing for determining the position of the lens 12 and the flash 54 with respect to the photographic subject of a person H in image capture mode.

In step 100, the face detection unit 62 extracts a face region of the person H from the image data captured by the image capture unit 60 in the image capture mode, and the routine then proceeds to step 102.

Whether or not there is a face region extracted at step 100 is determined at step 102. When determined that there is a face region the routine then proceeds to step 104, and when determined that there is no face region the routine then proceeds to step 122.

At step 104, the horizontal/vertical directions of the face F are determined from the face data extracted at step 102, and the routine then proceeds to step 106.

At step 106, the verification unit 66 determines whether or not the readied digital camera 10 is in the vertical orientation based on the horizontal/vertical direction of the face F determined at step 104. When the digital camera 10 is determined to be in a vertical orientation (i.e., affirmative determination) the routine then proceeds to step 108.

At step 108 the verification unit 66 determines whether the flash 54 is positioned below with respect to the lens 12, on the basis of the positional information from the component position information acquiring unit 68. If the result of the determination is that the flash 54 is positioned below the lens 12 (i.e., affirmative determination) then the routine proceeds to step 110, and when determined that the flash 54 is positioned above the lens 12 (i.e., negative determination), the routine then proceeds to step 122.

Determination is made at step 110 whether or not the flash 54 will be emitted, independent of whether the flash 54 is in the automatic flash mode for automatically emitting a flash or the flash 54 is in the override (forcible) flash mode in which a flash is always emitted. When affirmative determination is made that a flash will be emitted from the flash 54, the routine then proceeds to step 112, and negative determination is made that no flash will be emitted, the routine then proceeds to step 122.

At step 112, a message like the one shown in FIG. 6 is displayed on the LCD 18 as a warning to the photographer, and the routine then proceeds to step 122.

At step 106, when determined that the digital camera 10 is not in the vertical direction (i.e., negative determination), the routine then proceeds to step 114.

At step 114, the verification unit 66 determines whether or not the readied digital camera 10 is in the horizontal orientation based on the horizontal/vertical direction of the face F detected at step 104. When the digital camera 10 is readied in the horizontal orientation the routine then proceeds to step 116, and when the digital camera 10 is not in the horizontal orientation (i.e., negative determination) the routine then proceeds to step 122.

At step 116, the verification unit 66 determines if the flash 54 is positioned below with respect to the lens 12, based on the positional information from the component position information acquiring unit 68. As a result of the determination, if affirmative determination is made that the flash 54 is positioned below the lens 12 then the routine proceeds to step 118, and if negative determination is made that the flash 54 is positioned above the lens 12, the routine then proceeds to step 122.

At step 118, determination is made as to whether a flash will be emitted, either when the flash 54 is in the automatic flash mode and when the flash 54 is in the override flash mode. When affirmative determination is made that the flash 54 will emit a flash the routine then proceeds to step 120, and when negative determination is made that no flash will be emitted, the routine then proceeds to step 122.

At step 120, a message like the one shown in FIG. 6 is displayed on the LCD 18 as a warning to the photographer, and the routine then proceeds to step 122.

Determination is made at step 122 whether to perform image capture or not. When negative determination is made that no image capture to be performed the routine then proceeds to step 100, and face extraction is executed. When the determination is affirmative that the image capture is to be performed, the routine then proceeds to step 124.

Image capture processing is performed at step 124 and the routine then proceeds to step 126.

The captured image is stored at step 126 and the routine is terminated.

In the first exemplary embodiment, determination is made of the horizontal/vertical direction of the face F based on the position of parts of the face F of the person H, and the horizontal/vertical orientation of the readied digital camera 10 is determined. When, based on the horizontal/vertical orientation of the readied digital camera 10 and based on the positional information of components thereof, it is determined that the flash 54 positioned below the lens 12, the flash 54 will emit light from below with respect to the person H and unnatural shadows will be applied to the person H. Therefore, in order to prevent unnatural shadows of the person H from the flash 54 emission, a message warning the photographer is displayed on the LCD 1 S. Thus, determination can be made of the horizontal/vertical orientation of the readied digital camera 10, without an additional component for detecting the horizontal/vertical orientation of the readied digital camera 10.

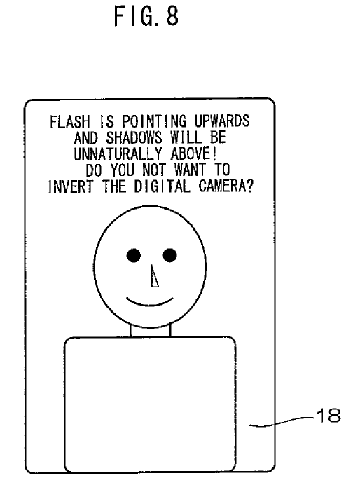

It should be noted that since determination is made of the vertical direction of the digital camera during image capture based on the determination of the horizontal/vertical directions of the face F and based on the positional information of the components of the digital camera 10, it is also possible to display the message for warning the photographer at the display of the digital camera 10 in an upper position of the digital camera 10 at the time of the image capturing, as shown in FIG. 8. By displaying the message in this manner the message is easily read by the photographer In order to carry out the above, the warning processing of steps 112 and 120 shown in FIG. 7 is undertaken so that the message is displayed at a position corresponding to the top of the digital camera 10 during the image capturing.

### Second Exemplary Embodiment

Explanation will now be given of a second exemplary embodiment of the present invention. It should be noted that similar elements of the configuration of the second exemplary embodiment to that of the first exemplary embodiment are allocated with the same reference numerals and explanation thereof is omitted.

A feature of the second exemplary embodiment is that, whereas the first exemplary embodiment relates to a photographic subject of a single person H, the horizontal/vertical orientation of the readied digital camera 10 is determined when there are plural persons H captured.

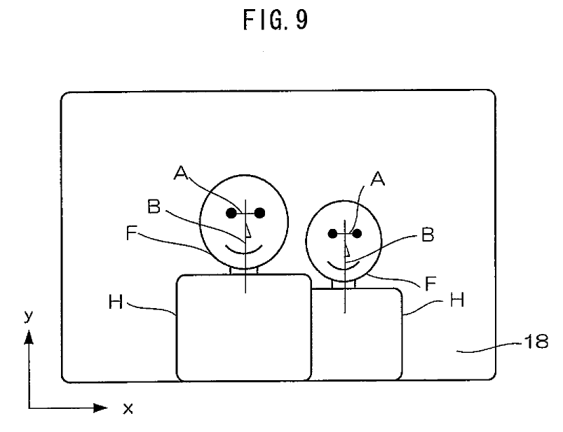

FIGS. 9 to 11A and 11B are drawings showing examples of determination of the horizontal/vertical orientation of the readied digital camera 10 according to the second exemplary embodiment. In the FIGS. 9 to 11A and 11B, in the same manner as in FIG. 5, the scanning direction in which the image capture elements of the CCD 22 are read out is designated the x-direction, and the direction orthogonal to the scanning direction is designated the y-direction.

When there are plural persons H present in such a manner as shown in FIG. 9, the straight lines A connecting the two eyes for both of the persons H are in the x-direction, and determination is made that the digital camera 10 is readied in the horizontal orientation.

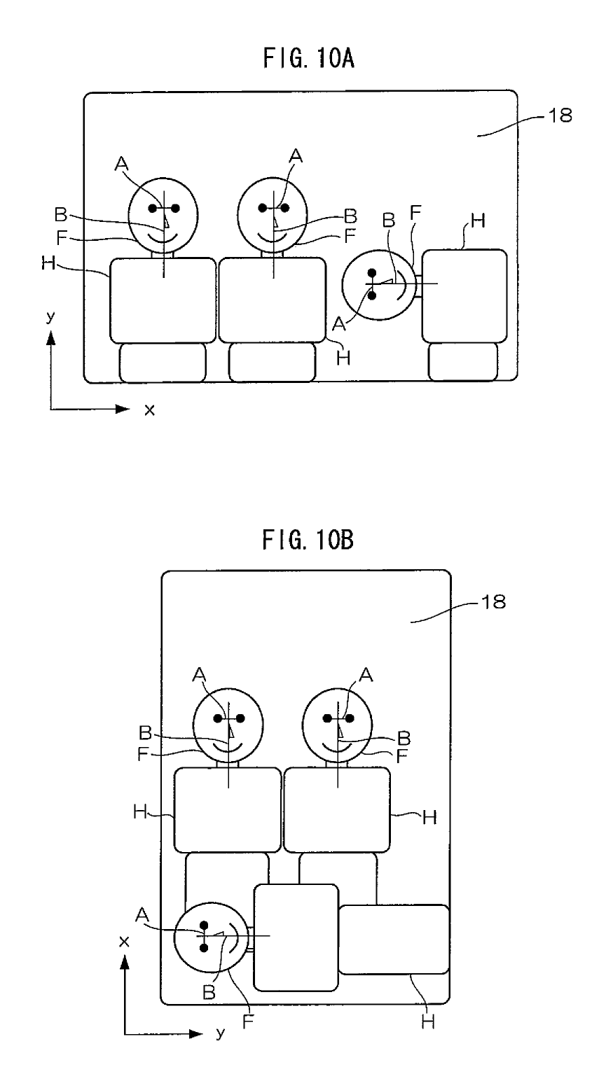

When there are plural persons H present as in FIG. 10A, there are both faces F in the vertical direction and faces F in the horizontal direction present together. The straight lines A connecting the two eyes of the plural persons H are two lines in the x-direction and one line in the y-direction. When there are plural persons H present and the vertical direction and horizontal direction of the faces are both present, determination is made in favor of the direction with the most counts. Accordingly, in the case of FIG. 10A, the direction of the face F is determined as the x-direction and the digital camera 10 is determined to be readied in the horizontal orientation.

In FIG. 10B there are plural persons H present, similar to in FIG. 10A, and both faces F in the vertical direction and faces F in the horizontal direction are present together. The straight lines A connecting the two eyes of the plural persons H are one line in the x-direction and two lines in the y-direction, and therefore, the y direction is determined to be the horizontal direction of the persons H. Determination is therefore made that the digital camera 10 is readied in the vertical orientation.

Explanation will now be given regarding a case in which plural persons H are present and there are the same numbers of faces F in the vertical direction as there are in the horizontal direction. In such a case, for each respective face F, the angle between perpendicular bisector line B of the straight line connecting the eyes A and the edge lines of the neck N is detected, and when a detected angle of each respective face is a specific angle or greater, the neck of the corresponding person H is determined to be bent. When plural persons H with bent necks are present, the determination of the overall direction (horizontal or vertical) of the faces F of the plural persons H is made using only those persons H who have an angle between the perpendicular bisector line B of the straight lines connecting the eyes A thereof and the edge lines of the neck N thereof which is smaller than a specific angle, i.e., the determination is made using only the one or more persons H whose necks are not bent. Thereby, the orientation of the readied digital camera 10 may be determined.

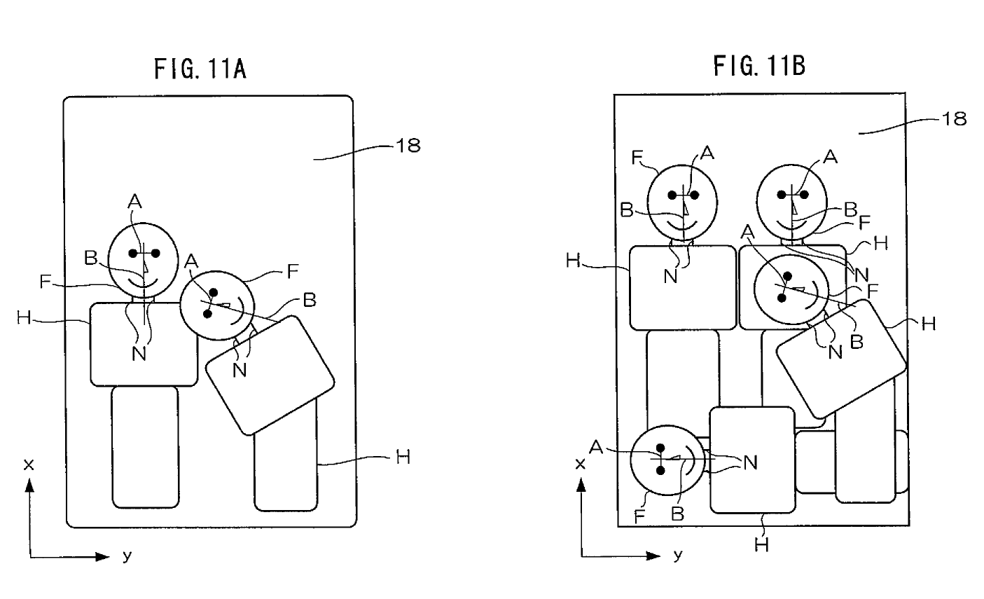

In the case of FIG. 11A, there are the same number of the straight lines A connecting the two eyes in the y-direction as in the x-direction, one of each. In this case, for the person H who has a straight line A connecting the two eyes in the y-direction, the perpendicular bisector line B of the straight line connecting the eyes A makes an angle with the edge lines of the neck N of smaller than a specific angle. For the person H with the straight line A connecting the two eyes in the x-direction, the perpendicular bisector line B of the straight line connecting the eyes A makes an angle with the edge lines of the neck N of a specific angle or greater, and the neck is bent. When the numbers are the same, the face F direction is determined using only the faces F having angles of smaller than a specific angle. Therefore, in the case of FIG. 11A, the y direction is determined to match with the horizontal direction of the faces F of the person H, and the digital camera 10 is determined to be oriented vertically.

In FIG. 11B there are two straight lines A that connect the two eyes in the y-direction and the same number, two, straight lines A that connect the two eyes in the x-direction. In this case for the persons H with straight lines A connecting the two eyes in the y-direction the angles made between the perpendicular bisector line B of the straight line connecting the eyes A and the edge lines of the neck N are of smaller than a specific angle. There is one person H, of the persons H with straight line A connecting the two eyes in the x-direction, who has an angle between the perpendicular bisector line B of the straight line connecting the eyes A and the edge lines of the neck N smaller than the specific angle, and there is one person thereof for whom the angle is the specific angle or greater, i.e., the neck of the person is bent. In this case, in FIG. 11B, since there are two straight lines A that count in the y-direction against one straight line A that counts in the x-direction, the horizontal direction of the faces F of the persons H are determined to be in the y-direction, and the digital camera 10 is determined to be readied in the vertical orientation.

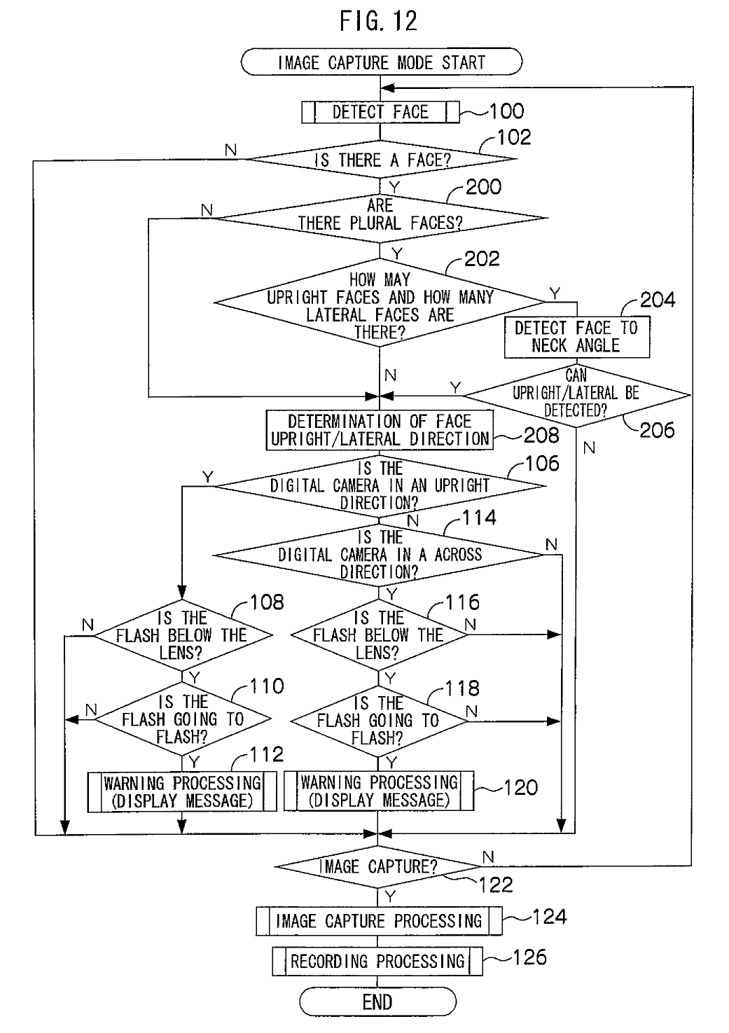

A flow chart is shown in FIG. 12 of the processing flow for determining the position of the lens 12 and the flash 54 with respect to a photographic subject of persons H for image capture when there are plural persons H present.

Determination is made at step 200 as to whether there are plural faces F of persons H extracted at step 100. When the determination is affirmative that there are plural faces F the routine then proceeds to step 202, and when the determination is negative that there are not plural faces F the routine then proceeds to step 208.

At step 202, determination is made as to whether there are the same number of faces F in the vertical direction as the number of faces F in the horizontal direction in the face data extracted at step 100. When affirmative determination is made that the numbers of the faces are same, the routine then proceeds to step 204, and when negative determination is made that there are not equal numbers of each, the routine then proceeds to step 208.

At step 204, detection is made as to whether, in the face data extracted in step 100, the angle made between the perpendicular bisector line B of the straight line connecting the eyes A and the edge lines of the neck N is equal to a specific angle or greater, and determination is made of the horizontal/vertical direction using the directions of the faces F having an angle smaller than the specific angle. After detecting the angles the routine then proceeds to step 206.

At step 206, determination is made as to whether it is possible to determine the horizontal/vertical direction of the faces F from the angles detected in step 204. When affirmative determination is made that it is possible to determine the horizontal/vertical direction of the faces F the routine then proceeds to step 208, and when negative determination is made that this is not possible the routine then proceeds to step 122.

At step 208, when the determination at step 202 is negative and the number of vertical direction faces F is not to the same as the number of horizontal direction faces F, the orientation is determined in favor of the horizontal/vertical direction with the greatest number of faces F. When the angles made between the perpendicular bisector line B of the straight line connecting the eyes A and the edge lines of the neck N have been detected at step 204, the horizontal/vertical direction is determined using the faces F of the people who do not have a bent neck, i.e., having the angle smaller than the specific angle. When the horizontal/vertical direction of the faces F has been determined the routine then proceeds to step 106.

In the second exemplary embodiment, more accurate determination of the horizontal/vertical direction of the face F is possible when image capturing plural persons H. In addition, more natural shadows can be obtained from the flash 54 even when there are persons H lying down or persons H with a face F facing toward the side the horizontal/vertical direction of each of the faces F can be determined, since the orientation of the readied digital camera 10 can be detected from the horizontal/vertical direction of the faces F, and since determination is made as to whether the flash 54 is below the lens 12 or not. Furthermore, when neck(s) of the persons are in a bent state, the orientation of the faces F can be determined with precision by detecting the angle formed between the perpendicular bisector line B of the straight line connecting the eyes A and the edge lines of the neck N.

In the second exemplary embodiment the horizontal/vertical direction orientation is determined based on the orientation having the greatest number of faces F when there are plural persons H for image capture, and the horizontal/vertical direction is determined using the faces F of person(s) H who do not have bent necks when there are person(s) H with bent necks. However, there is no limitation to such a determination method, and determination may prioritize the horizontal/vertical direction of the faces F the person(s) H with bend necks or the like, or the photographer may change such parameters and the like.

In the first and second exemplary embodiments, the face(s) F detected with the face detection unit 62 need not be limited to the faces of person(s) H, and for example, the faces of animals may be detected. The settings for face detection may be selectable by changing the detection parameters by switching between a person mode and an animal mode or the like.

Furthermore, when image capturing a person H who is doing a hand stand or image capturing an upside-down person H, depending on the image capture method there may be occasions when the desired operation will not function. However, occurrences of such image capture are rare, and the effect thereof is slight, since image capture is possible even though a message is displayed as a warning, as shown in the flow charts of FIG. 7 and FIG. 12.

In the first and second exemplary embodiment, the flash 54 is positioned below the lens 12 when the digital camera 10 is readied as in (3-1) of FIG. 5, however there is no limitation to such a layout. Since the positional relationship of the flash 54 and the lens 12 can be ascertained, by the component position information acquiring unit 68 acquiring positional information of the components, the present invention is applicable wherever the flash 54 is positioned in the digital camera 10.

In addition, if a warning is issued when the flash 54 emits light from below the lens 12, this information may be stored as supplementary information, in a tag region in an Exif (Exchangeable Image File Format) or the like.

What is claimed is:

1. An image capture device comprising:
an image capture unit that acquires image data by image capturing a photographic subject by image capture elements using an optical system component;
an auxiliary light source, positioned away from the position of the optical system component in a specific direction, that outputs auxiliary light substantially simultaneously with the image capture by the image capture unit;
a face region extraction unit that extracts a region corresponding to a face from the captured image data;
a determination unit that determines the orientation of the face in the extracted face region of the image data on the basis of at least the position of the image capture unit in a rotation direction centered around the image capture optical axis;
a relative position information acquiring unit that acquires relative position information of the optical system component with respect to the auxiliary light source on the basis of the determination result of the determination unit; and
a notification unit that gives a notification when the acquired relative position information matches predetermined reference information, the notification comprising information relating to the match.

2. The image capture device according to claim 1, wherein the predetermined reference information relates to the state of a shadow of the photographic subject generated by the auxiliary light output from the auxiliary light source.

3. The image capture device according to claim 1, wherein the predetermined reference information represents a relative positional relationship in which the position of the auxiliary light source is below the position of the optical system component in the direction of gravity.

4. The image capture device according to claim 1, further comprising a display unit for displaying the captured image data,
wherein, when the predetermined reference information matches the position information, the notification unit displays the information relating to the match in an orientation corresponding to the orientation of an upright image of the photographic subject, regardless of the orientation of the image capture device during image capture.

5. The image capture device according to claim 1, wherein when a plurality of face regions are extracted, the determination unit determines, as the face orientation to be compared with the predetermined reference information, a face orientation that substantially matches the greatest number of face orientations of the plurality of face regions.

6. The image capture device according to claim 1, wherein when a plurality of face regions are extracted and there is more than one face orientation that substantially matches the greatest number of face orientations of the plurality of face regions, the determination unit determines a neck of a face to be bent if the angle formed between the perpendicular bisector of a straight line connecting the two eyes of the face of the photographic subject and an edge line of the neck of the photographic subject is a specific angle or greater.

7. The image capture device according to claim 1, wherein when a plurality of face regions are extracted and there is more than one face orientation that substantially matches the greatest number of face orientations of the plurality of face regions, the determination unit compares the orientation of faces having an angle that is smaller than a specific angle formed between the perpendicular bisector of a straight line connecting the two eyes of the face of the photographic subject and an edge line of the neck of the photographic subject, and determines the overall face orientation to be the face orientation that substantially matches the greatest number of face orientations of the compared faces.

8. An image capture method comprising:
acquiring image data by image capturing a photographic subject by image capture elements using an optical system component;
optionally outputting auxiliary light from an auxiliary light source, positioned away from the position of the optical system component in a specific direction, substantially simultaneously with the image capture by the image capture unit;
extracting a region corresponding to a face from the image data captured during image capture when auxiliary light is outputted by the auxiliary light source output;
determining the orientation of the face in the extracted face region image data, with respect to the optical system component;
acquiring relative position information of the optical system component with respect to the auxiliary light source on the basis of the determined result; and
giving a notification when the acquired relative position information matches predetermined reference information the notification comprising information relating to the match.

9. The image capture method according to claim 8, wherein the reference information relates to the state of a shadow of the photographic subject generated by the auxiliary light output from the auxiliary light source.

10. The image capture method according to claim 8, wherein the reference information represents a relative positional relationship in which the position of the auxiliary light source is below the position of the optical system component in the direction of gravity.

11. The image capture method according to claim 8, further comprising displaying the captured image data,
wherein, when the predetermined reference information matches the position information, information relating to the match is displayed in an orientation corresponding to the orientation of an upright image of the photographic subject, regardless of the orientation during image capture.

12. The image capture method according to claim 8, wherein when a plurality of face regions are extracted, the face orientation to be compared with the predetermined reference information is determined to be a face orientation that substantially matches the greatest number of face orientations of the plurality of face regions.

13. The image capture method according to claim 8, wherein when there are a plurality of face regions extracted and there is more than one face orientation that substantially matches the greatest number of face orientations of the plurality of face regions, a neck of a face is determined to be bent if the angle formed between the perpendicular bisector of a straight line connecting the two eyes of the face of the photographic subject and an edge line of the neck of the photographic subject is a specific angle or greater.

14. The image capture method according to claim 8, wherein when there are a plurality of face regions extracted and there is more than one face orientation that substantially matches the greatest number of face orientations of the plurality of face regions, comparison is made between the orientations of faces having an angle that is smaller than a specific angle formed between the perpendicular bisector of a straight line connecting the two eyes of the face of the photographic subject and an edge line of the neck of the photographic subject, and the overall face orientation is determined to be the face orientation that substantially matches the greatest number of face orientations of the compared faces.
